(19) United States
(12) Patent Application Publication
(10) Pub. No.: US 2004/0032400 A1
(43) Pub. Date: Feb. 19, 2004

(54) Method and systems for managing the display of digital content

(76) Inventors: Mark T. Freeman, Bellevue, WA (US); Scott A. Laster, Snohomish, WA (US)

Correspondence Address: LAW OFFICES OF RONALD M. ANDERSON, Suite 507, 600-108th Avenue N.E., Bellevue, WA, 98004, US

(21) Appl. No.: 10/640,965

(22) Filed: Aug. 13, 2003

Related U.S. Application Data
(60) Provisional application No. 60/403,733, filed on Aug. 14, 2002.

(51) Int. Cl. G09G 5/00

(52) U.S. Cl. 345/173

(57) ABSTRACT

Methods and systems for managing the display of digital image content. In one example, a host system that includes a computing device and a fixed storage device is connected by a network to a remote display device and optionally, to the Internet. The host system stores a plurality of digital images and parameters for controlling the selection and transmission of a subset of the images to the remote display device for viewing. The display device includes a processor and display screen, as well as a user interface for input of control instructions—preferably, a touch sensitive display screen. In one method of managing the images displayed, the host system continuously transmits new selected images to the display device where they are temporarily cached and displayed. A selected image may be manipulated or transmitted to outside parties by extemporaneous user instructions.

### RELATED APPLICATIONS

This application is based on a co-pending provisional patent application, Ser. No. 60/403,733, filed on Aug. 14, 2002, the benefit of the filing date of which is hereby claimed under 35 U.S.C. § 119(e).

### FIELD OF THE INVENTION

The present invention generally relates to data management and display, and, more particularly, pertains to a data management and display system with both passive and active control for selecting digital image content stored or accessed through a computing and fixed storage device, routing the selected content to the appropriate display devices, displaying the content in both predefined and on demand processes, and selectively sharing the content over a network for display by other users at other locations.

### BACKGROUND OF THE INVENTION

The rapid rise in the popularity of digital cameras and digital photography has brought with it a new problem of how best to display the images created in the process for the best enjoyment of all interested persons. Typically, digital images are either printed to a hard copy, or viewed on a computer display terminal. Each of the two methods commonly in use today has disadvantages. Printing digital images is expensive, which negates much of the advantage of using a digital camera to inexpensively capture a virtually unlimited number of images when desired. Also, printed images generally do not have the same visual resolution, color matching, or lasting durability as prints produced from film used in traditional cameras. Storage and access of images also becomes a problem as the number of images grow into the thousands. Viewing an image on a personal computer terminal display resolves most of the problems associated with printed output, but is often inconvenient. Locating an image for presentation on a computer display requires an active effort on the part of a user and is not conducive to more that one person enjoying the images at one time. Although software programs are available that assist a user in indexing images so that they can more readily be located, such programs still do not address the problems that arise in displaying the images so that they can be enjoyed by others.

Some efforts have been made to facilitate the display of images in the form of small digital picture frame devices that have recently been produced by companies such as Kodak, Polaroid, Sony, Digi-Frame, and Ceiva. Although these devices are a step forward, they have many drawbacks, including limited capacity, and lack of flexibility and usefulness. Clearly, a better method and system would be desirable for managing the display of digital image content for the benefit and enjoyment of multiple concurrent viewers.

### SUMMARY OF THE INVENTION

The present invention overcomes the drawbacks of the prior art by combining the storage utility and capacity on a digital processing system, such as a personal computer or other portable computing device that is coupled to a fixed storage device, with one or more of a plurality of special purpose remote display devices connected to the processing system over a network. One embodiment of the present invention includes a system management software program that responds to user defined set-up parameters in executing processing and control applications installed and running on a digital processing system. This system is employed to process locally stored digital media images, which a user desires to display for viewing, and includes one or more display devices that are connected to the digital processing system by a network.

In one preferred embodiment, the digital processing system includes a personal computer or other portable computing device that is coupled to a fixed storage device. The computing device is connected to one or more display devices over a local area network (LAN), providing access to each storage device. The display device(s) are used for displaying locally stored digital media content in the form of digital pictures. The digital processing system is also connected to an outside network, such as the Internet, where the software program can access external third-party content for supplemental display and can transmit selected local content to outside locations for display sharing. In this embodiment, the display device(s) are preferably adapted to be hung on walls in areas that are conducive to easy group viewing. The display device(s) have touch control capability for invoking “on demand” display features at the display unit location. Also, in this embodiment, the LAN is preferably a wireless Ethernet network or a powerline type network that uses existing electrical wiring to provide maximum flexibility in selecting the physical location of each display device without the need for adding additional wiring. To use the system, the user selects the storage location of digital images on the processing system's storage medium through one of several available techniques, and selects parameters for image selection and display on each display device.

A system management program automatically searches the specified locations in the storage on initial set up, as well as periodically searching on a continuing basis. Images meeting the selection criteria are selected, converted to a standard format and resized according to the requirements of the specific display device, and then transmitted to that display device over the LAN for temporary storage and subsequent display. The user also can define selection criteria for a plurality of external third party content that is accessible through the program. Based on the defined selection criteria, the program periodically retrieves selected external third party content over the outside network (e.g., the Internet) and transmits that content to the appropriate display device over the LAN for temporary storage and on-demand initiated display. The computer user also selects certain system control criteria, such as the hours of operation, for each connected display device.

In this embodiment, each display device continuously selects digital images from its temporary storage, displays each image for its predefined time, and then deletes the image after a predefined number of additional images have been displayed. This automatic cycle continues throughout the user-defined hours of operation, unless interrupted by a user through an input command at the display device. In this embodiment, a user may tap on the display device's touch sensitive screen once, which will display a menu of “on demand” actions that a user may invoke. The on-demand actions are of three types, including: (1) Primary Content related functions; (2) Secondary Content related functions; and (3) display screen control functions.

Primary Content related functions generally fall into the following two types: (1) image manipulation functions that alter the predefined display cycle of the primary digital picture display; and, (2) image transmission functions that enable the user to selectively send a digital image to an outside party (i.e., someone not connected to the LAN) for viewing. As examples of the image manipulation functions that can be accomplished using the touch menu to enter commands at the display device, a user can pause the display cycle so that the display device continually displays a single image, or cause the continuous display of a previous image, or advance to continually display the next image, or resume the normal display cycle. Another example of the available image manipulation functions is extemporaneously deleting an image from the display set so that it will not be displayed on the device again. With the image transmission functions, a user may use the touch menu to select a particular image to send to someone at a different location. This command will invoke the display of a list of contacts set up on the host computer system from which the user may chose one or more names of persons to whom the chosen image will be sent over an outside network, such as the Internet. After the user has selected the name(s), the user will enter a “send” command, which will transmit the image and intended recipient identification information from the display device back to the host for execution. For example, the selected image may be sent to recipients through an email program previously installed on the same host as the software comprising the present invention. In another example, the selected image may be transmitted directly to someone using a similar system for immediate display on that system, utilizing a proprietary peer-to-peer network feature that connects the two systems over the Internet or other external network. The selected image may also be transmitted to a service provider for purposes such as ordering printed copies of the image.

Secondary Content related functions include additional content display commands that control the temporary display of other third party content on the display device. With additional content display commands, a user can selectively display any of a plurality of other third party content items that have been set up in the program. As examples of additional content display commands, a user may selectively display a content web page for current local weather information, or display a web page listing sports scores from the most recent games played by selected teams.

Display screen control functions include commands to turn the display device screen on or off at times other than the normal hours of operation that the user specified in the set-up parameters for the system management software program.

In a preferred embodiment, the system also includes malfunction warning functionality to alert the user if the host and a display device are not communicating, and automated update features to enable remote, unattended update of the system software on both the host and the display devices, as may be needed from time-to-time to correct software errors and to accommodate the incorporation of newer technology and functionality.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a block diagram of a system overview illustrating a host computer system with a connection to the Internet and with a wireless network connection to a display device in accord with the present invention;

FIG. 2A is a block diagram of the components of the display device;

FIG. 2B is a side cut-away view of the display device;

FIG. 2C is a functional block diagram of a single board computer like that used in the display device;

FIG. 3 is a process flow diagram illustrating the steps used for registering a display device on the host processing system;

FIG. 4 is a process flow diagram illustrating the steps used for setting up images stored on the host processing system (i.e., the Primary Content) for viewing on a selected display device;

FIG. 5 is a process flow diagram illustrating the steps for managing the viewing of images stored on the host processing system with the display device;

FIG. 6 is a process flow diagram illustrating the steps for selecting and setting up digital content not stored on the host processing system (i.e., the Secondary Content) for selected “on demand” viewing on a display device;

FIG. 7 is a process flow diagram illustrating the steps for retrieving the Secondary Content from an outside content provider to make it available for viewing on a display device;

FIG. 8 is a process flow diagram illustrating the steps for setting up the main operating parameters for control of the system on the host processing system;

FIG. 9 is a process flow diagram illustrating the method of modifying the normal operating schedule for the display devices connected to the system in a response to a user override;

FIG. 10 is a flow chart diagram illustrating the normal operating process of the system when it is not interrupted by user input;

FIG. 11 is a process diagram illustrating the method of continually moving image Primary Content from the host processing system through a display device during a display cycle;

FIGS. 12A and 12B are a process flow diagram showing the method of extemporaneously controlling the image content viewing at a display device, including image manipulation and selecting images being viewed for transmission to outside parties;

FIG. 13 is a process flow diagram illustrating the method of preparing and transmitting images selected in FIG. 11 from the host processing system to the outside parties over the Internet;

FIG. 14 is a process flow diagram illustrating the method of extemporaneously selecting and viewing Secondary Content at a connected display device;

FIG. 15 is a flow chart and functional diagram illustrating the menu structure and operating process of the system when it is interrupted by user input through a display device;

FIG. 16 is a flow chart illustrating the method of identifying, changing the normal operating process, and alerting the user of a system malfunction when a connection is lost between a host processing system and a registered display device; and

FIGS. 17A-17C are a flow chart showing the method for automatically updating the software on the host processing system and/or registered display devices to keep the systems current.

### DESCRIPTION OF THE PREFERRED EMBODIMENT

The following description and drawings are illustrative of a preferred embodiment of the present invention and are not to be construed as limiting the scope of the invention. Numerous specific details are described to provide a thorough understanding of the present invention. However, in certain instances, well known and conventional details are not discussed in order to not unnecessarily obscure an understanding of the present invention and its functionality.

In order to disclose the full context of this preferred embodiment of the present invention, the following description discusses a host configuration that employs a LAN and preferably is connected to an external public network, such as the Internet. It will be appreciated, however, that the present invention may be used with a stand-alone host system, which is not connected to an external public network. Other aspects of the present invention may, but are not required to use functions provided by a connection to the external public network, such as a conventional email program.

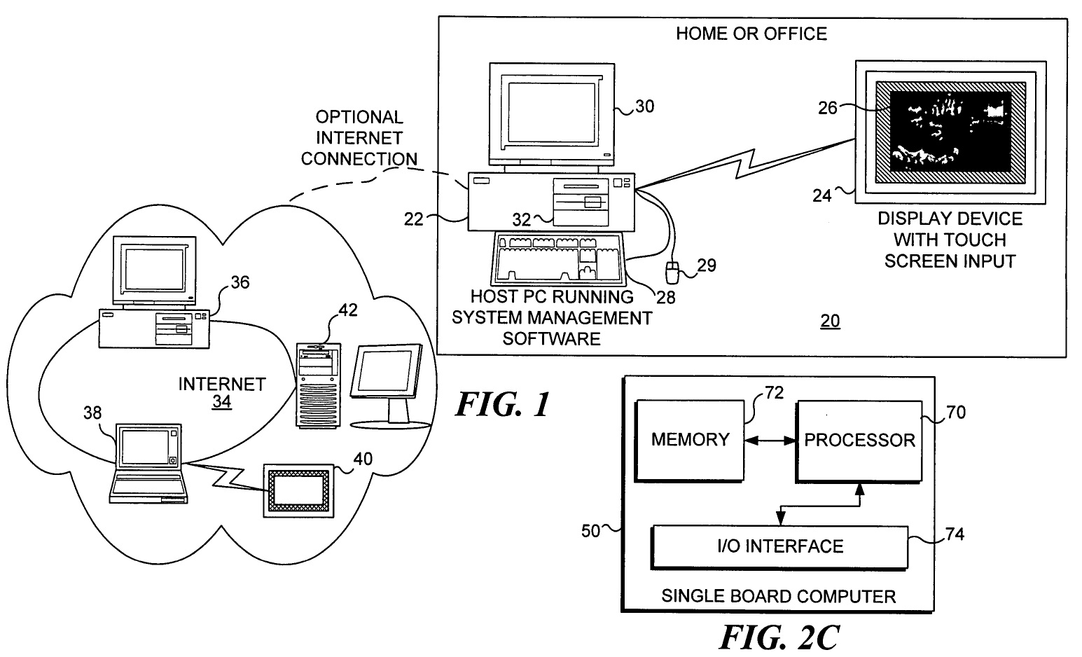

FIG. 1 shows a typical system configuration 20 with a host 22 running the software of this invention and connected by a wireless LAN to at. least one display device 24 that will typically be disposed somewhere in the same home or office building as the host. The host processing system (hereafter referred to as “host”) also preferably has an outside connection to the Internet. The host is a desktop personal computer (PC) having a monitor 30, a keyboard 28, a mouse (or other pointing device) 29, and hard drive storage 32, as shown in FIG. 1, but could alternatively be a laptop computer or a next generation portable computing device coupled with a fixed storage device. The network is preferably a wireless network capable of transmitting/receiving data securely between points at a rate of at least 1 MB/sec at a range of 100 ft. or more through normal internal building structures, but could alternatively be either an electrical powerline based network, a conventional Ethernet cable based network, or some other type of network that is yet to be developed. The display device(s) are limited function special purpose computer systems with display screen(s) 26 manufactured in a form factor to facilitate wall mounting in a common picture frame. Internet 34 provides communication between host 22 and a plurality of other computing devices, of which computing devices 36, 38, and 42 are shown only as representative examples. Note that computing device 38 is a laptop computer that is also coupled by a wireless network to a display device 40, in accord with the present invention.

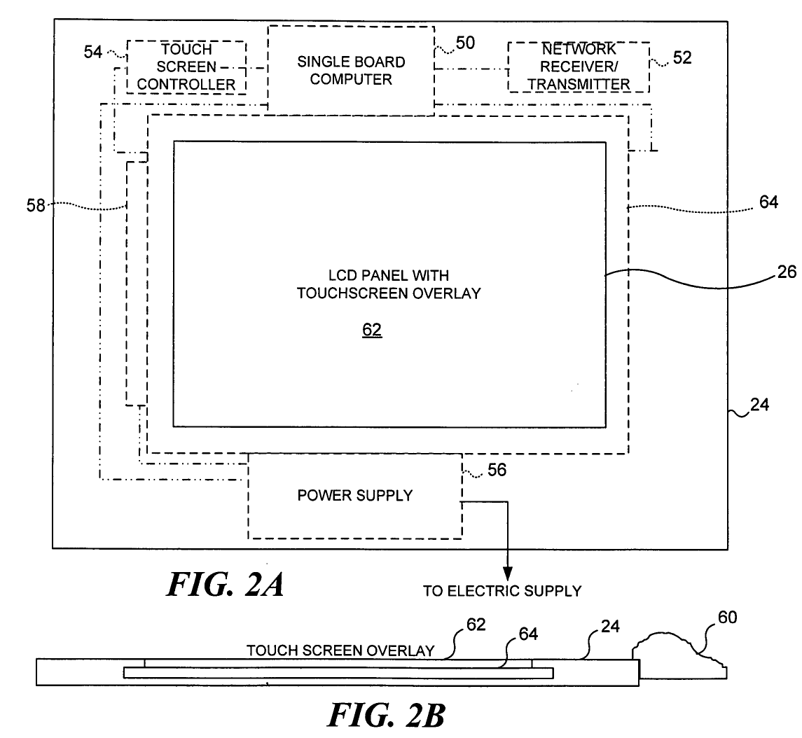

FIGS. 2A, 2B, and 2C show further detail of display device 24. The display device includes a single board computer 50 (or similar system controller), which drives thin profile display 26. Display 26 includes a liquid crystal display (LCD) panel 64 and a backlight inverter 58, a touch sensitive outer screen 62 and a controller 54, a power supply 56 that produces appropriate voltages to drive the electronic components, and one or more network transmitters and receivers 52, all packaged so as to be suitable for mounting in a standard picture frame 60 (see FIG. 2B), which enables the display device and picture frame to be hung on a wall (not shown) or otherwise displayed so that a plurality of people can preferably view the images that are being shown on display device 24. The single board computer executes appropriate operating system software (depending upon the type of processor employed), along with the display device control software of the present invention, which causes the display device to implement the functionality described below. As shown in FIG. 2C, single board computer 50 includes a processor 70, a memory 72 (with both random access memory (RAM) and read only memory (ROM)—not separately shown), and an input/output interface 74 for coupling to touch sensitive screen 62 and the wireless transmitter and receiver.

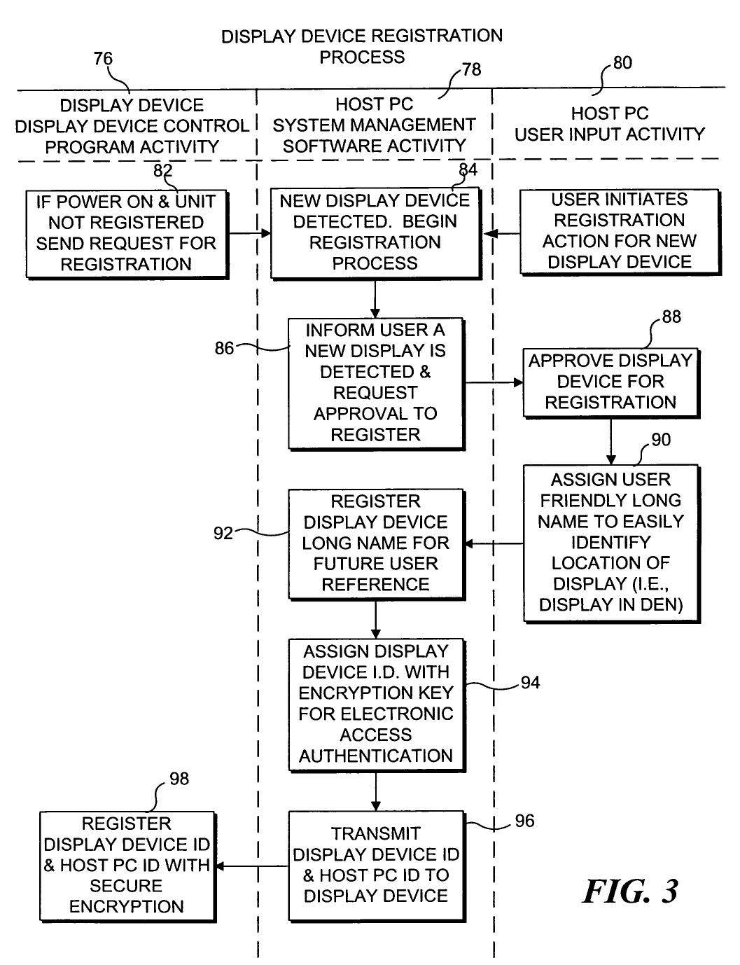

FIG. 3 illustrates the steps of a method for connecting and registering one or more display devices to a host. The steps shown in this and a number of the other Figures are located under column headings that identify the specific component/activity associated with carrying out the step. Thus, the column headings in FIG. 3 include a column 76 labeled, Display Device, Display Device Control Program Activity, a column 78 labeled Host PC, System Management Software Activity, and a column 80, labeled Host PC, User Input Activity. The system will identify and register a plurality of remote electronic display devices over a network connection to a single host for the purpose of transmitting and displaying selected content stored on the host on one or more of the devices. When a display device is initially powered up, it checks to determine if it is registered with the host PC, and if not, sends a request for registration, as indicated in a step 82. The display devices are uniquely identified to the host and will receive display content only from the registering host. Identification includes a user friendly name which will easily identify the device and its location to an end user, as well as specific information about the particular display, such as display screen size and resolution, that is necessary for the program to properly display graphic images on the device for satisfactory viewing. The registration is performed by the system management software of this invention running on the host in communication over the network with display control software of this invention running on each display device, as indicated in a step 84. In a step 86, the user is informed that a new display device has been detected, and the user is requested to approve registration of the display device. Alternatively, the user may initiate the registration process through the host PC using the system management software. Each display device should have a unique encrypted identifier assigned at the moment of registration by the system management software. This identifier is used in binding the display device(s) to a specific host for security and control purposes and in assigning options for a specific display device or group of units. The user approves the registration of the display device, as per a step 88. In a step 90, each display device is also assigned a user friendly name to enable easy identification of the unit to the user (i.e. Display in Den), which is registered by the host PC in a step 92. The display device is also assigned a specific encrypted host identification code so it will accept images and content only from the specific authorized host program, in a step 94. In a step 96, the host PC transmits the display device ID and host PC ID to the display device, and in a step 98, the display device completes the registration using secure encryption for communications between the display device and the host PC.

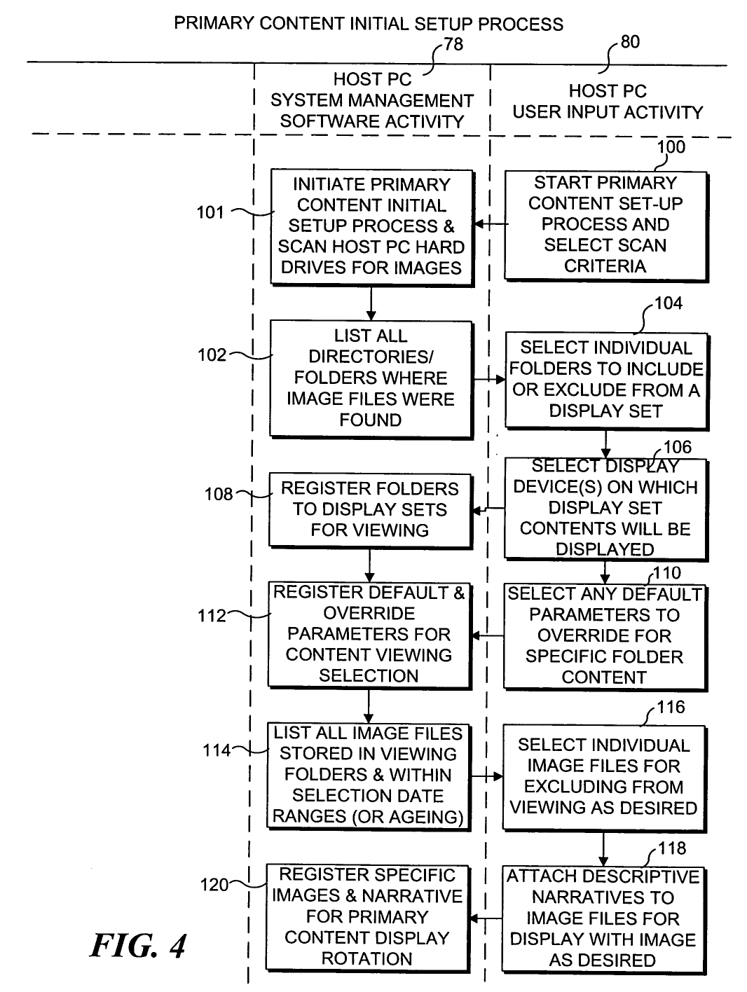

FIG. 4 illustrates the steps for setting up the system to display images (Primary Content) stored on the host. During an initial setup, the host PC carries out a scan of the hard drive to identify Primary Content on the host computer that is to be displayed on each remote display device and sets certain viewing parameters such as frequency and length of display time that are input by the user (or uses default values for these parameters). Primary Content includes digital photographs, picture files, and other static graphic image content that the user may want to display on the remote display device(s). The identification process also allows for attaching certain user prepared information to any selected image file for display with that image. Identification includes a one time set-up process the first time the software program of the present invention is loaded on a host.

In a step 100, the user starts the set-up process and selects scanning criteria such as specific drives or folders for the program to scan for image files. In step 101, the setup process selectively scans the hard drive(s) of the host based on the user selected criteria, to identify folders that contain image files commonly associated with digital photographs and other picture files (JPEG, GIF, TIF, etc.). Scan results will identify to the user or list each folder where image files were found, in a step 102. Under column 80, the user may then elect to include or exclude images in each identified folder for viewing in a selected display set and assign the display set to one or more display devices in steps 104 and 106. The image folders are registered to specific display sets for viewing in a step 108. At this time the user may also select one or more specific image files in an included folder to be excluded from display in a step 116, and may add optional narrative data to be displayed with the image in a step 118. The specific images selected and any narrative attached are registered for the Primary Content display rotation (i.e., for the display cycle implemented by the display device) in a step 120.

The user will set-up, by action or default, selected viewing parameters to control certain aspects of image viewing, in a step 110, and the default and selected viewing parameters that control the image viewing are registered on the host PC in a step 112. Selected viewing parameters that the user may set-up include, but are not limited to file date ranges, current date aging (that determines how long images will be used for display before a new set of images is loaded), file viewing duration, and image transition effects. In a step 114, the images files stored in the selected viewing folders that are within the selected date ranges or within the date ageing limits are listed for consideration by the user and action according to step 116.

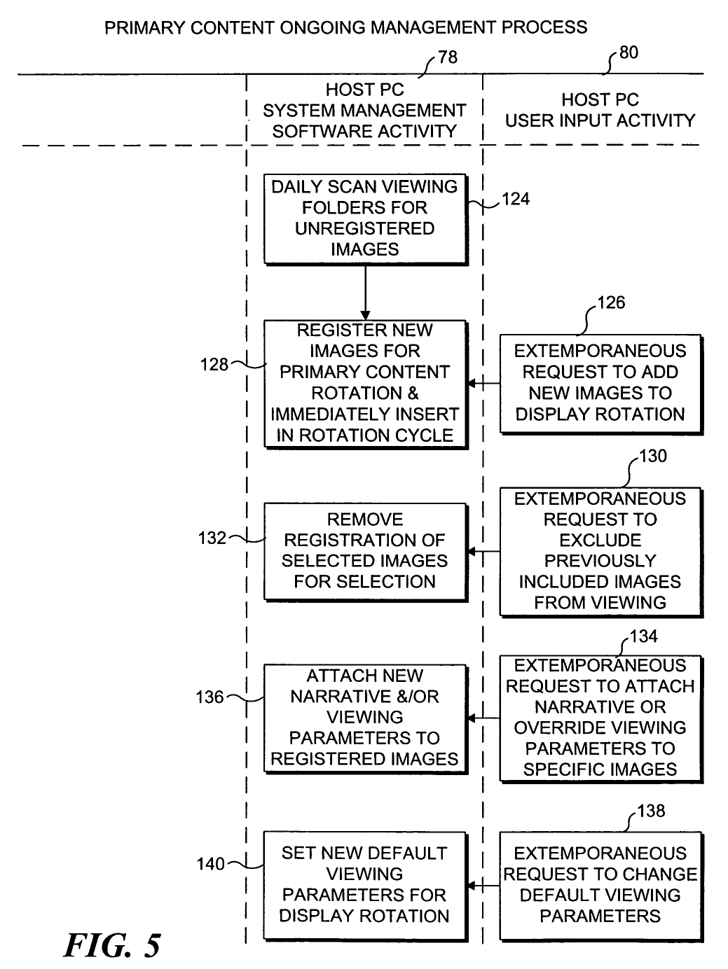

In FIG. 5, a process flow diagram, shows the steps for managing the display of Primary Content subsequent to initial set-up. Image identification includes an automated ongoing process, such as daily, to include new content that is added to folders on the host after the initial set-up process is completed, as indicated in a step 124. Subsequent to initial set-up, the system will automatically include for display selection any new image files that are added to an included folder. These new images are registered for Primary Content in a step 128 and immediately included in the rotation cycle for images being displayed, in response to an extemporaneous request to add the new images input by the user on the host PC, as indicated in a step 126. The user may at any time elect to exclude individual images from being displayed, as noted in a step 130, which causes the registration for such images to be removed, as indicated in a step 132. Also, the user can request to add or delete narrative to image files, or override the viewing parameters previously input, for specific image files, as indicated in a step 134. The new narrative is attached to selected image files, and the viewing parameters are registered in regard to the selected image files in a step 136. In a step 138, a user can make a request to change the default viewing parameters, which are then changed in accord with the user input in a step 140.

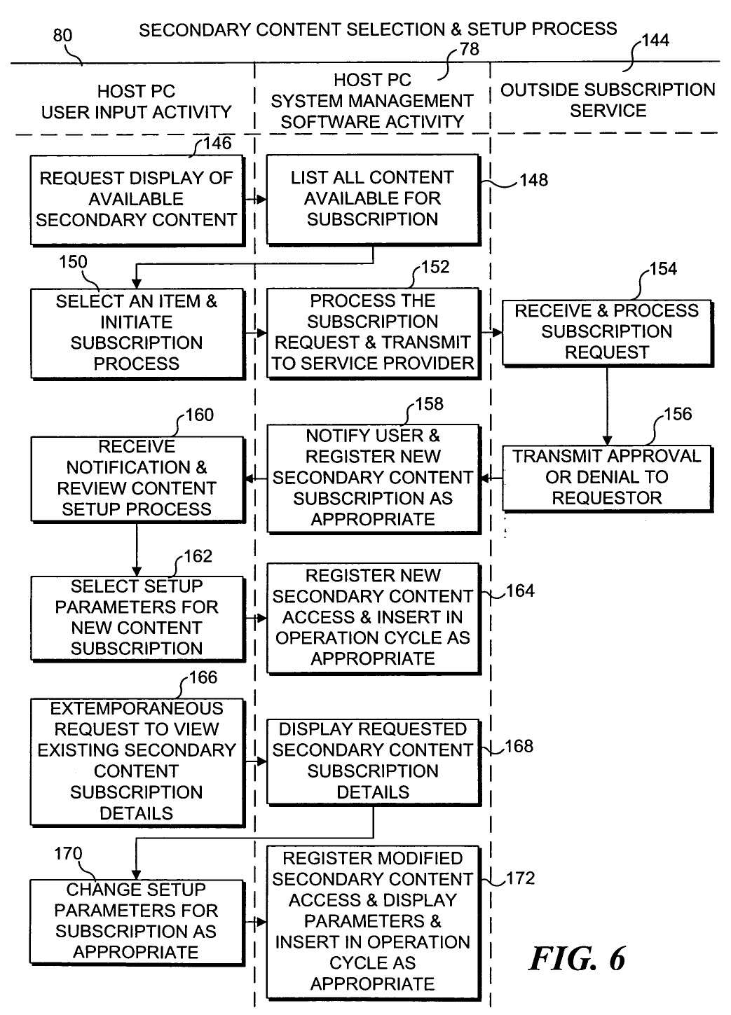

A process flow showing the steps of a method used to set up the system management software program to access certain items of dynamic content not normally stored on the host (Secondary Content) so that the user may extemporaneously request temporary viewing of the content at a display device is provided in FIG. 6. This functionality requires that the host be connected to an outside network, such as the Internet, to access an outside subscription service, as indicated in a column 144. The system will identify and set-up Secondary Content for “on demand” display, when requested by a user, in accord with a step 146. Secondary Content includes certain dynamic information that may be available to the system from third party sources accessible by the host. Examples of such information includes, but are not limited to, current weather conditions and forecasts for a given geographic location at a point in time, the current trade price of a selected stock and the latest scores and game highlights for sporting events of a selected team. At any time during or after initial set-up, the user may select items of Secondary Content from a universe of available items for “on demand” display or listing at any of the unique display devices comprising the user's system, as noted in a step 148. Depending on the item selected in a step 150, the user will be required to enter one or more selection parameters relating to that item. In a step 152, the host PC will process the subscription request and transmit the request to the appropriate service provider. As indicated in a step 154, the subscription service receives and processes the request and in a step 156, transmits an approval or denial to the requester. If accepted, the host PC notifies the user and registers the new Secondary Content subscription in a step 158. In a step 160, the user receives the notification on the host PC and reviews the Secondary Content setup process. The user selects setup parameters for the new content subscription in a step 162. In a step 164, the host PC registers the new Secondary Content access and inserts the content into the operation or display cycle as appropriate. The parameters selected by the user may include, but are not limited to, a United States zip code as a way to define a geographic location for a weather reporting selection. Selection parameters may also include such items as the frequency that selected content is updated. On the host PC, in a step 166, the user may make an extemporaneous request to view the existing Secondary Content subscription details, causing the host PC to display the requested Secondary Content subscription details in a step 168. Upon reviewing the details, the user may change the setup parameters for the subscription as appropriate, as indicated in a step 170, so that in a step 172, the host PC registers the modified Secondary Content access and display parameters and applies them to the operation cycle, as appropriate.

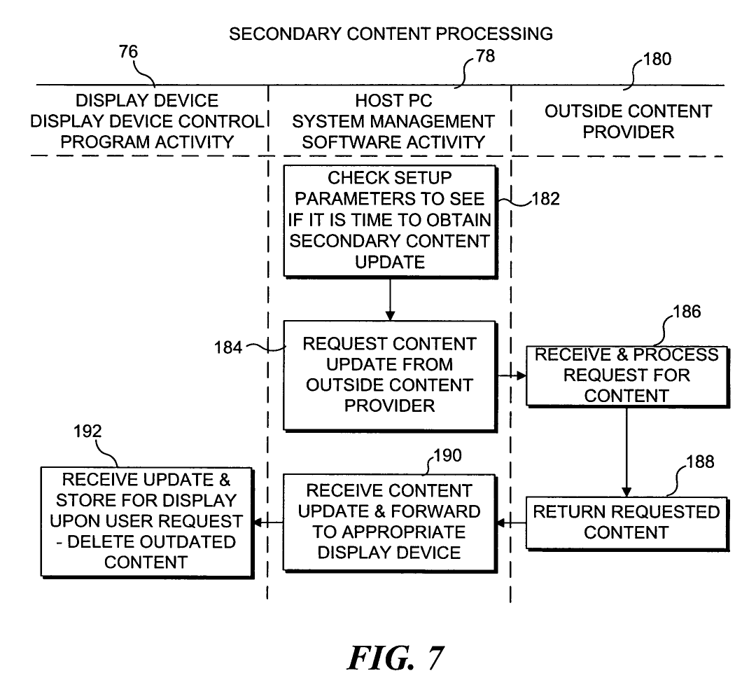

FIG. 7 is a process flow diagram showing a method of processing items of Secondary Content by the system management software program after set-up. In this Figure, a column 180 on the right indicates the steps carried out by the outside Secondary Content provider. Subsequent to selection of Secondary Content, the system (host PC) will automatically access the source of the Secondary Content through an electronic network such as the Internet, based on either the user defined or system defined update frequency, as indicated in a step 182. Next, in a step 184, the host PC requests a content update from the outside content provider, and in a step 186, the outside content provider receives and processes the request for content. The requested content is returned in a step 188. The host PC receives the returned content in a step 190, and the system will then send the most current version of the content to the display device(s) for storage and “on demand” display. In a step 192, the display device receives the update and stores it for display upon user's request. Any out of date content is deleted in this step.

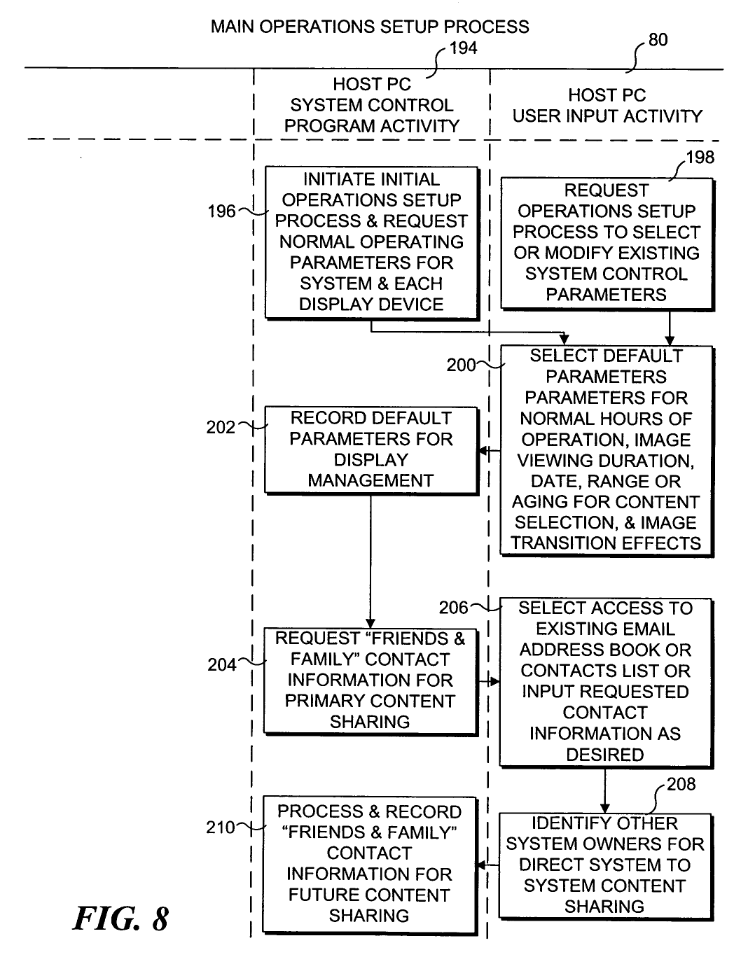

The steps of the method for configuring the system management software program to control the day-to-day operation of the attached display devices are shown in FIG. 8. System operations are handled by system management software for the present invention that is installed on the host PC. The set-up application of the system management software program will run automatically during the initial set-up process in a step 196, and thereafter as noted in a step 198, may be evoked through a menu selection process by the user when required to make changes. The software will require valid data input for each system control parameter, in a step 200. Program edits will warn and prohibit invalid data entry. The software will enable the user to set up and manage certain operating parameters for each display device. The system control parameters include, but are not limited to, functions such as normal hours of display operation, Primary Content source, image transition effects, and management of data necessary for the sharing of selected Primary Content with others outside the user's system. The default parameters selected by a user are recorded by the host PC in a step 202. Input data to control the sharing of selected Primary Content may include, but are not limited to, data identifying specific other user's systems and/or email contact information for other people. The host PC requests “Friends & Family” contact information for sharing Primary Content in a step 204, and a user can select access to an existing email address book or contacts list or alternatively, input the requested contact information as desired, in a step 206. Peer-to-peer communication between display devices over the Internet is also possible, to enable sharing of content, so that in a step 208, the user may identify other system owners for direct system-to-system content sharing. The host PC processes and records the “Friends & Family” contact information and other information provided by the user for connecting with others for future content sharing, in a step 210.

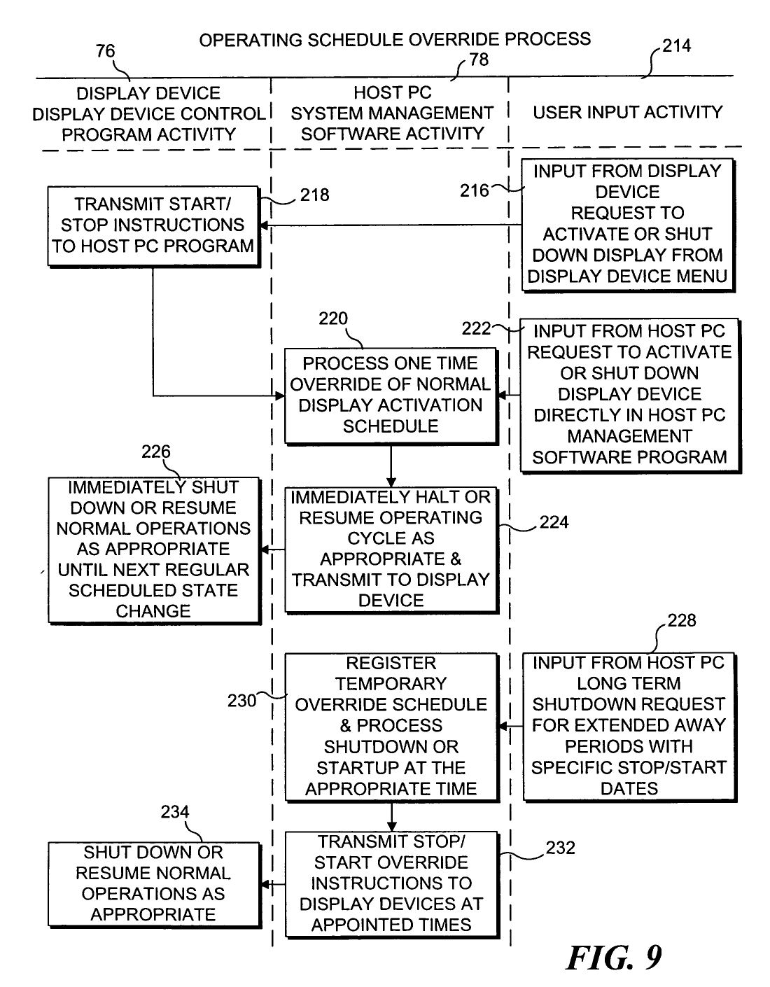

FIG. 9 includes a column 214 for user input activity and illustrates the steps of a method to temporarily override certain system control parameters set up in the software. Temporary override capability may be evoked from either the host through the system management software program, as indicated in a step 222, or from an individual display device through a menu selection item in a step 216 that will send the override instructions to the host PC in a step 218. The host PC processes a one time override of the normal display activation schedule in a step 220. In a step 224, the host PC immediately halts or resumes the operating cycle on the indicated display device, as appropriate, by transmitting the required instructions to the display device, as noted in a step 226. Upon receiving the instructions in a step 226, the display device immediately shuts down or resumes normal operations, as appropriate, until the next regular scheduled state change, e.g., until the next regularly scheduled time to start or interrupt the operational cycle. The most common override is in regard to hours of operation, allowing the user to stop or start a particular display device at times other that those set up in the system management software. In addition, a user may use a host PC to input a long term shut down, for extended away periods (such as when the people in a house with the display device are away on vacation), with specific stop/start dates, as indicated in a step 228. The host PC will then register the temporary override schedule change and process the shutdown or startup at the appropriates times requested, in a step 230. At the required times/dates, the host PC will transmit stop/start override instructions to the display device(s), as provided in a step 232, and as noted in a step 234, the display device(s) will shut down or resume normal operation, as appropriate.

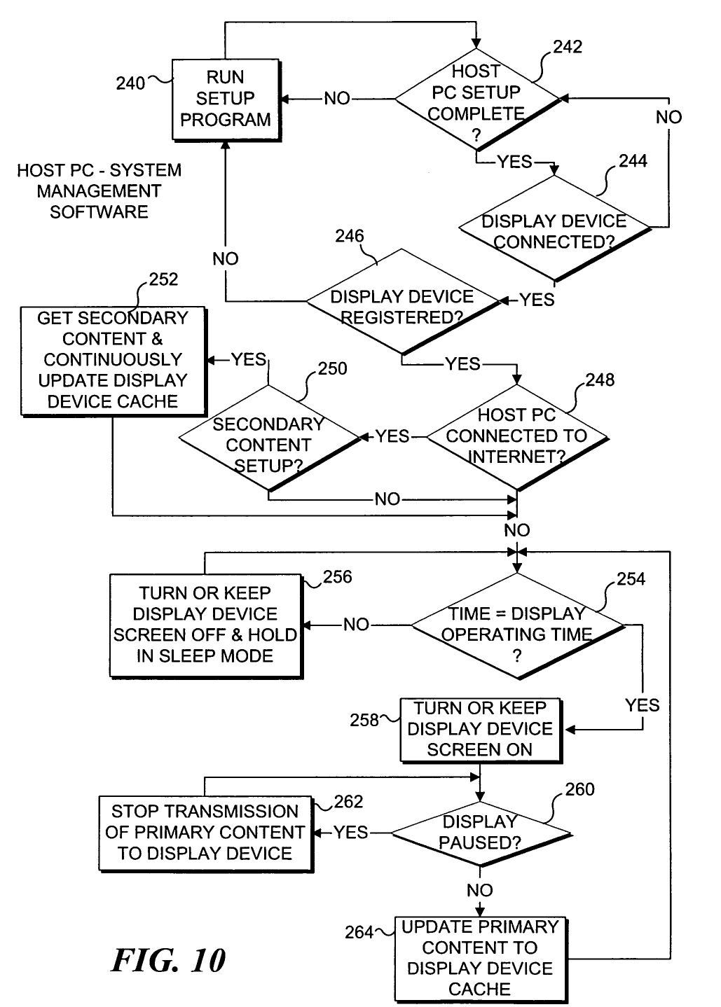

A flowchart showing the steps implemented during the normal operating state of the system management software program is provided in FIG. 10. The system management software will run as a continuous service or background application on the host. During normal operation, the host PC and a display device will be in continuous communication (Attached Mode). In Attached Mode the system management software on the host will control the operation of each display device. It will instruct the device when to power on and when to turn off. While a display device is powered on in Attached Mode and not paused, the host PC will continuously transmit new Primary and Secondary Content to that display device according to the user set-up parameters for each type of content, and the host PC will handle the processing of outgoing communications initiated by a user through a display device.

Initially, in a step 240, the host PC will run the setup program until a decision step 242 determines that the host PC setup is complete. A decision step 244 then determines if a display device is connected and if not, continues looping back to step 242 until a display device is connected. After the display device is connected, a decision step 246 determines if the display device has been registered by the host PC and if not, returns to step 240. However, if the display device has been registered, a decision step 248 determines if the host PC is connected to the Internet. It so, a decision step 250 determines if Secondary Content has been set up, and if so, proceeds to a step 252. Step 252 gets the Secondary Content and updates the display device cache. Thereafter, the logic proceeds with a decision step 254. Decision step 254 is carried out without secondary content if there is a negative response to decision step 250 or decision step 248.

Decision step 254 determines if the current time is equal to the display operating time that was set by the user, and if not, a step 256 turns off the display device or keeps it off and holds it in a sleep mode. This logic continues until an affirmative result is obtained in decision step 254. At that time, a step 258 turns the display device on or keeps it on. A decision step 260 then determines if the display has been paused, and if so, a step 262 stops the transmission of Primary Content to the display device. Conversely, if the display has not been paused, a step 264 updates the Primary Content to the cache of the display device.

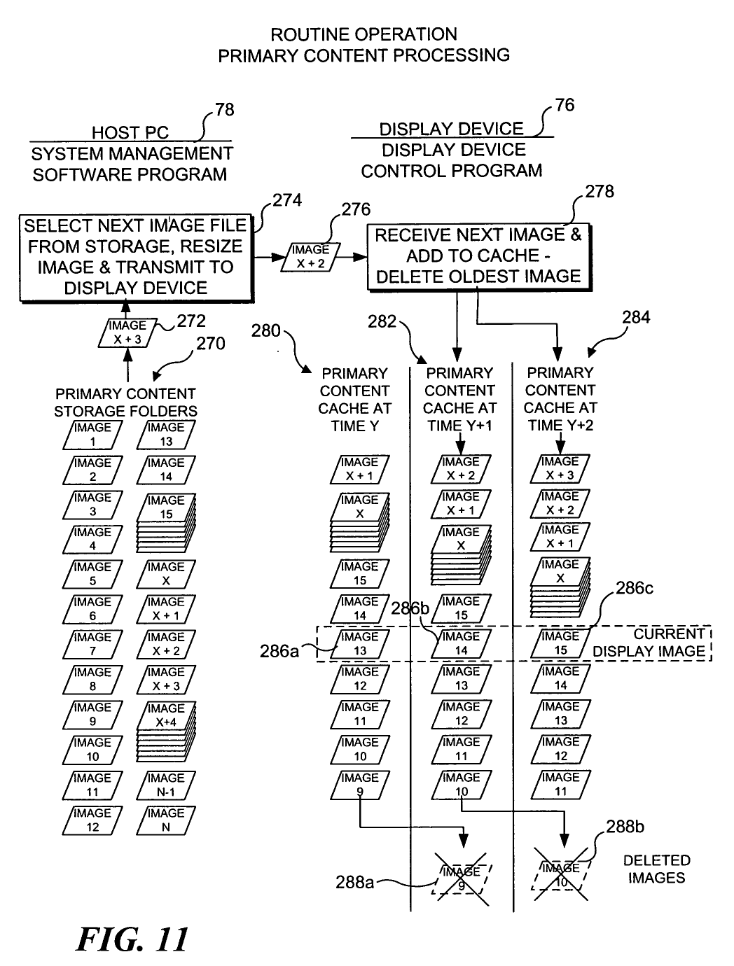

FIG. 11 illustrates the Primary Content image processing that occurs between the host PC and a display device. Primary Content images 270, which are stored on the host PC, may be of many different file types and sizes. Prior to transmitting an image 272 to the display device, the system management software will automatically scale the image file size for optimum transmission and viewing in a step 274, based on the specifications of the particular display device. A processed image 276 will then be transmitted to the display device, which in a step 278, receives the next image and adds it to the caches. After the cache has been filled, the oldest image is deleted from the cache as a new one is added. Each display device will store a predefined number of Primary Content images within the device's temporary electronic memory cache. A program within the unit will draw the images from the cache for display on the screen. Sufficient images will be stored in the cache to allow the user reasonable flexibility to manually move the image display forward or backward without requiring new images to be transmitted from the host while the display is paused. Columns 280, 282, and 284 respectively show the Primary Content in the cache at times y, y+1, and y+2. At each of these three times, images 286a, 286b, and 286c are respectively displayed on the display device. As a new image is added to the cache at time y+1, an image 288a is deleted, and as the next image is added at time y+2, an image 288b is deleted from the cache. Thus, when the display is not paused and the cache is full, the system will delete the oldest image from the cache memory each time a new image is received from the host.

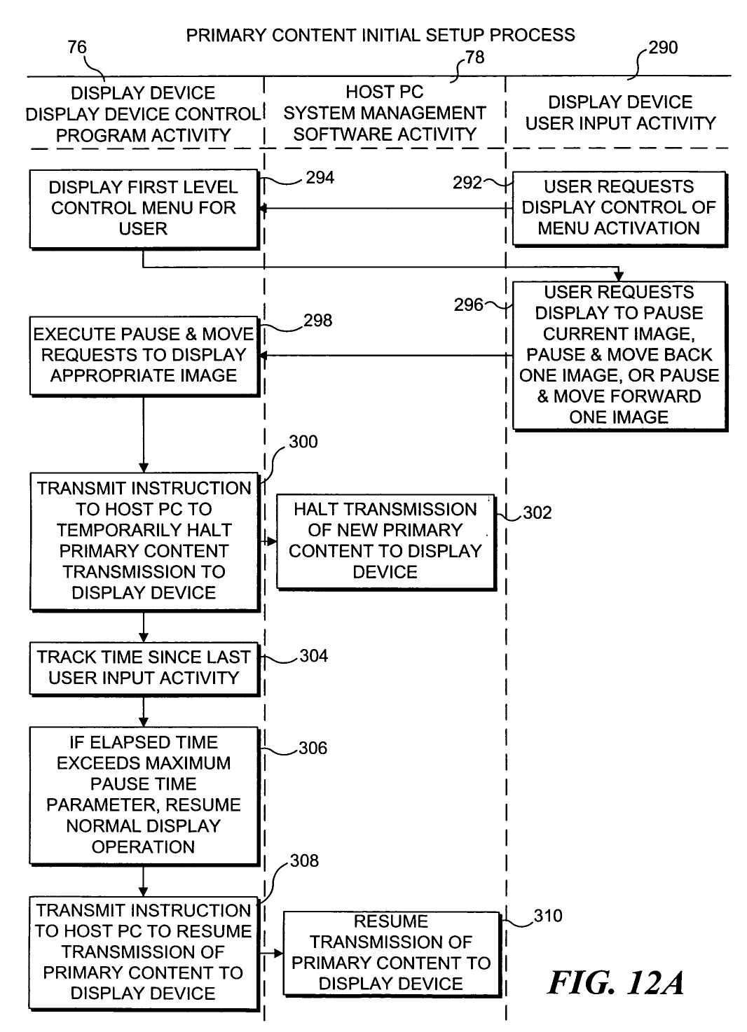

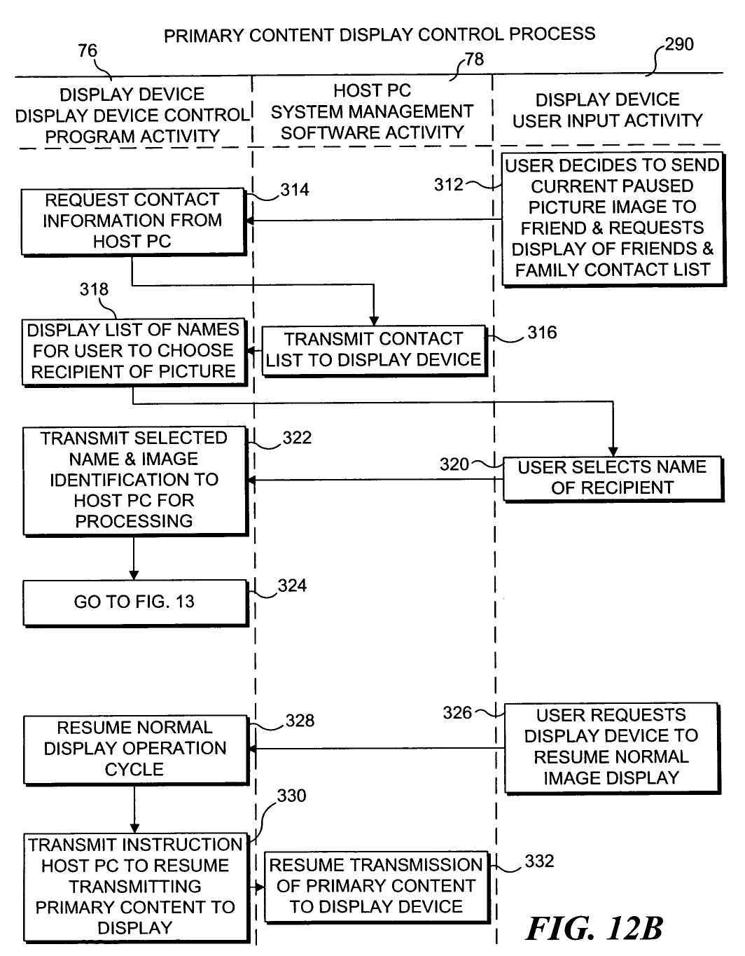

FIGS. 12A and 12B illustrate the steps for controlling Primary Content by user initiated input from a display device (as indicated in a column 290). The system will allow certain extemporaneous control by users through the display devices. This control is intended to evoke selected display control functions during normal operation. Such functions include override selection and control of the current Primary Content display item as well as the sharing of Primary Content with others outside the user's system. Primary display control functions are executed by the display control software and include, but are not limited to, the ability to pause the current Primary Content display image, move the image display forward or backward one image at a time, delete an image from the display set, and resume the normal display cycle. A user request display control menu activation in a step 292 and in response, in a step 294, the display unit displays a first level control menu for the user. A step 296 then enables a user to request the display device to pause the current image, pause and move back one image, or pause and move forward one image. The display device responds to the input in the control menu in a step 298 and executes the instruction input by the user on the touch screen menu, and in a step 300, transmits an instruction to the host PC to temporarily halt Primary Content transmission to the display device. The host PC responds to the instruction in a step 302, by halting transmission of primary content. A step 304 keeps track of the elapsed time since the last user input activity occurred on the display device touch screen. As noted in a step 306, if the elapsed time exceeds a predefined maximum pause time parameter, the display device resumes normal display operation. The display device transmits an instruction to the host PC to resume transmission of Primary Content to the display device, in a step 308, and in response, in a step 310, the host PC resumes transmission of Primary Content to the display device.

Primary Content display control also enables the user to send an electronic copy of the current display image to another selected person outside of the user's own system (LAN). The method of image transmission may include, but is not limited to, peer-to-peer networking for other persons who have similar display device systems, or common email transmission of images to other users over the Internet or other public network.

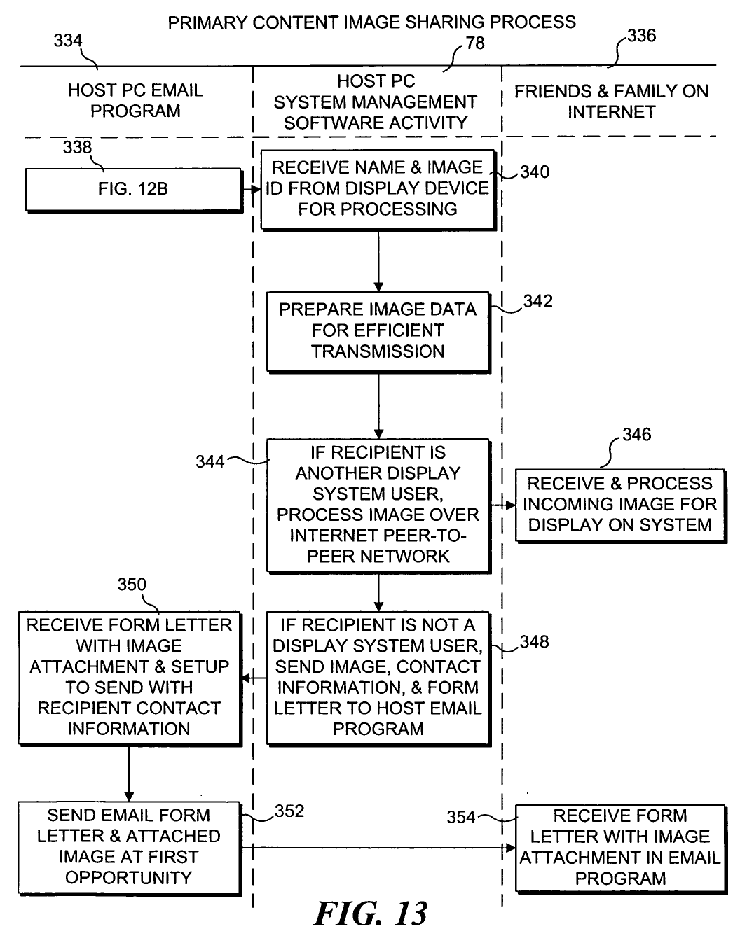

In a step 312, a user decides to send a current paused image to a friend and requests display of the Friends and Family contact list. As noted in a step 314, the display device requests contact information from the host PC. In a step 316, the host PC transmits the contact list to the display device. A list of names are then displayed in a step 318 so that the user can choose the recipient of the image. In a step 320, the user selects the name of the intended recipient of the image, and in response, a step 322 provides for transmitting the selected name and image identified by the user to the host PC for processing. Further steps of the process are identified in FIG. 13, as indicated in a block 324.

After the user is done with any of the Primary Content control functions they may resume normal display in a step 328, through a menu command initiated by a user in a step 326. The display device will transmit an instruction to the host PC to resume transmitting Primary Content to the display device in a step 330, and in response, in a step 332, the host PC will resume transmitting Primary Content to the display device. Or, the display control software will automatically revert to the normal operation display cycle after a specified period of time without further user input, as noted above in step 306.

In FIG. 13, the steps for handling requests on the host PC to send selected images to outside parties are shown. This Figure includes a column 334 for steps carried out by a host PC email program, and a column 336 for steps carried out in connection with Friends & Family on the Internet. A block 338 indicates the steps that were carried out in FIG. 12B when a user wants to send an image to another person or system. The identification of the person who will be the recipient and the identification of the image to be sent are received by the host PC in a step 340. In response, the system management software program on the host PC will process the requests to transmit selected images to others by preparing the image data for efficient transmission, in a step 342. If the recipient is identified in the system as another system owner, the image will be transmitted directly by the system management software over a peer-to-peer (direct computer-to-computer) network connection established over the Internet in a step 344. The other system will receive and process the incoming image for display, in a step 346. If the recipient is not another system owner, the system management software will evoke the default email program resident on the host and transmit the image as an email attachment in steps 348, 350, and 352. The recipient will receive the form letter with the attached image in the email program running on the recipients computer, in a step 354.

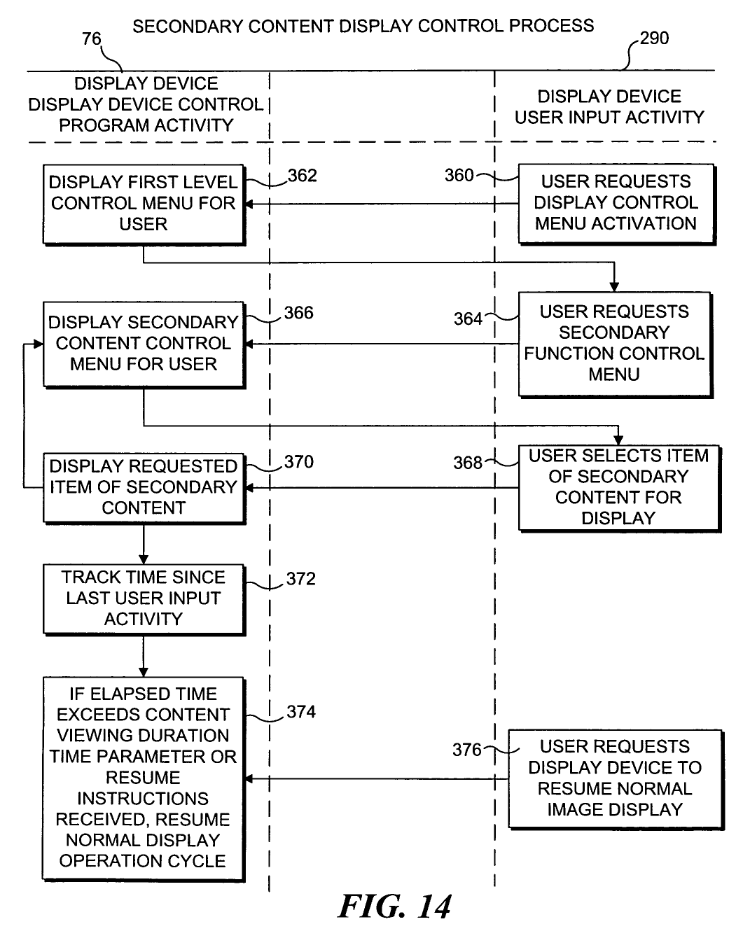

FIG. 14 includes the steps for controlling Secondary Content by user initiated input from a display device (column 290). In a step 360, the user requests display control menu activation, and in response, in a step 362, the display device will display a first level control menu for the user to make a selection. In a step 364, the user requests a secondary function control menu. In response, in a step 366, the display device displays a Secondary Content control menu for the user. Secondary display control functions are executed by the display control software and include the ability to selectively view Secondary Content evoked by menu selection. When evoked, Secondary Content temporarily overrides the Primary Content display. Using the secondary function control menu, in a step 368, the user selects one of the items from the Secondary Content for display. A step 370 provides for displaying the requested item of secondary content, followed either by returning to step 366, or continuing with a step 372. Menu selection will reflect each item of Secondary Content a user is authorized to receive. As noted in a step 376, the user can request that the display device resume normal image display. After selecting and viewing Secondary Content, the user may resume normal display by selecting an appropriate menu command, or the display control software will automatically revert to the normal operation display cycle after a specified period of time without further user input. Step 372 tracks the time elapsed since the last user input activity. If, in a step 374, the elapsed time exceeds a content viewing duration time parameter, or if resume display instructions are received by the display device, the display device resumes the normal display operation cycle.

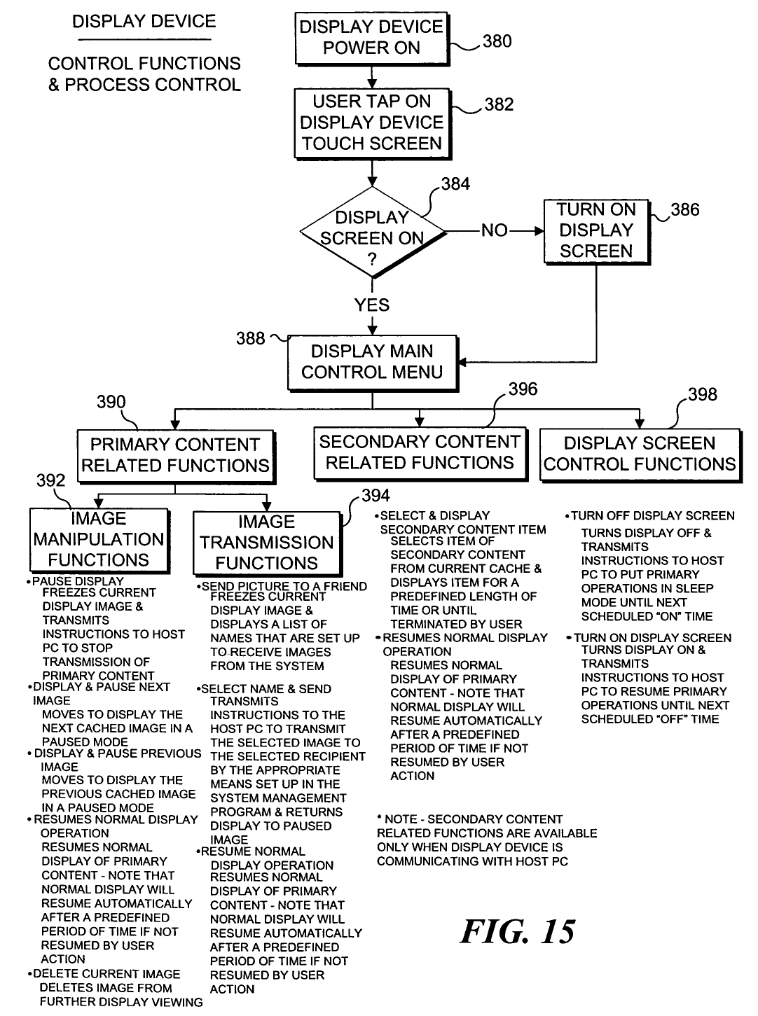

A chart further illustrating the display control software menu activation process and functionality is shown in FIG. 15. In this chart, a step 380 indicates that the display device is energized. Menus are activated on the display device by the user touching anywhere on the touch sensitive screen surface, as indicated in a step 382. A decision step 384 determines if the display screen is on. If the user action occurs while the display screen is in the “off mode,” the display screen will immediately turn on in a step 386 and then display the first level menu in a step 388. If the display device is already on, the menu will simply override the current display view and display the first level or main control menu in step 388. Once the menu is displayed, individual display control items 390, 396, or 398 may be selected by touching the appropriate menu section of the display screen. Active display menus may be deactivated any time by selecting the appropriate menu option. Displayed menus will deactivate automatically after a set period of time if the user evokes no further commands. The length of time a specific menu is displayed before it automatically deactivates is established by default parameter in the system management software but may be modified by the user as desired. Control item 390 includes Primary Content related functions, i.e., image manipulation function 392 and image transmission functions 394. Control item 396 includes Secondary Content related control functions, while control item 398 includes display screen control functions. The columns under each of the functions noted above provide further details.

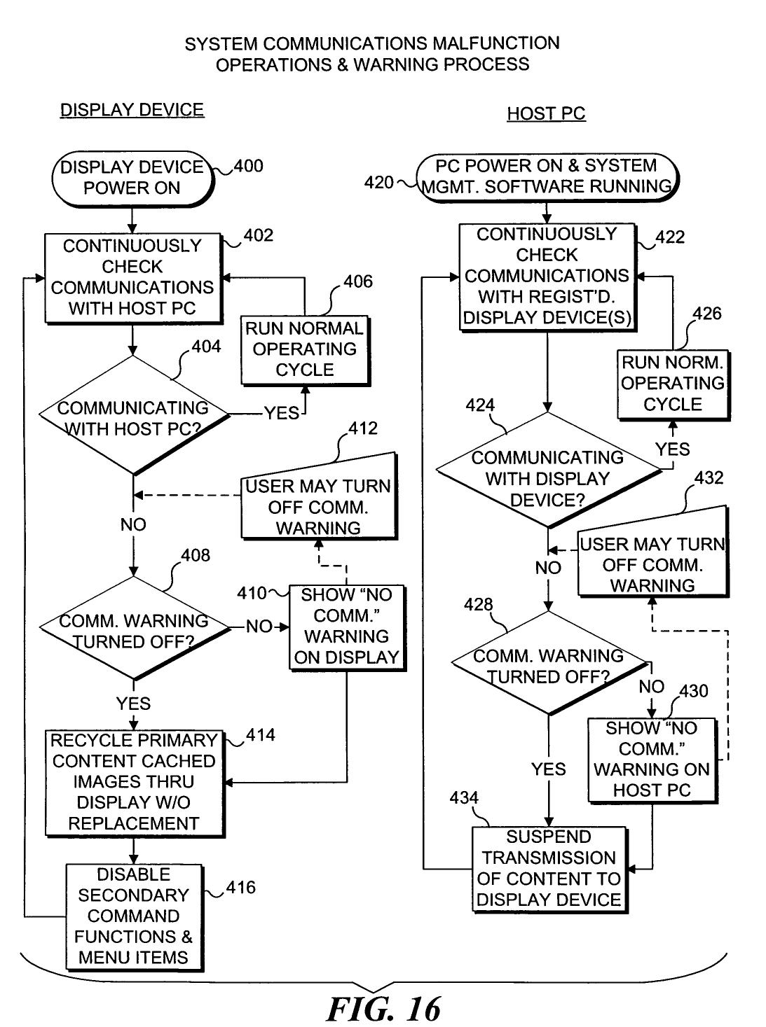

FIG. 16 is a flowchart illustrating the changes that occur in the normal operation process when the host and a registered display device have lost communications. The system will have built-in diagnostic and warning indicators to detect when a host and registered display device are not communicating and alert the user from either the host or the related display device. At any time during the established normal hours of operation, if the host and a registered display device are not communicating for longer than the established Primary Display single image cycle time, a visual trouble indicator will activate on both the host and the effected display device. The trouble indicator will remain active until communication is restored or the indicator is deliberately turned off by the user. If the display device is operating but is not currently communicating with the host PC, the display device will continue to operate (Detached Mode) during its predefined hours of operation unless specifically stopped by the user. In Detached Mode, the display device will continuously cycle the display through the Primary Content images that are then stored in its cache. The display will also provide a warning indicator that the unit is not communicating with the host unless, the indicator is disabled by the user. Secondary Content images will not be available for viewing in Detached Mode.

Details of the manner in which the display device handles system communication malfunctions are as follows. In a step 400, it is assumed that the display device is energized. A step 402 continuously checks communications between the display device and the host PC. A decision step 404 determines whether the display device is properly communicating with the host PC, and if so, a step 406 provides for running the normal operating cycle. If not, a decision step 408 determines if the communication warning indicator has been turned off. Assuming that the communication warning indicator is still operational, a step 410 shows a “no communication” warning on the display. As noted in a step 412, a user may optionally turn off the communication warning. If the communication warning indicator has been turned off, or after step 410, a step 414 begins recycling the Primary Content of cached images through the display, without replacement. Since communication with the host PC has been lost, a step 416 disables secondary content functions and menu items. The logic thereafter returns to step 402.

The host PC handles system communications malfunctions in accord with the following steps. A step 420 indicates that the host PC power is on and that the system management software is running. A step 422 continuously checks the communications between the host PC and all of the registered display device(s). In a decision step 424, a determination is made as to whether the host PC is properly communicating with each display device. If so, the host PC runs the normal operating cycle for the display devices, as indicated in a step 426. Otherwise, a decision step 428 determines if the communication warning indicator has been turned off (i.e., in a step 432), and if not, shows a “no communication” warning on the host PC in a step 430. After step 430, or if the communication warning indicator has been turned off, a step 434 suspends transmission of content to the display device. The logic thereafter continues with step 422.

The system management software of the present invention will periodically communicate over a network with a remote source of maintenance fixes and updates. The frequency of communication will be programmed automatically in the system management software, but may also be evoked manually at any time by the system user. An automated update utility application will be included in the system management software. The utility will maintain a record of the current version of the software on both the host PC and each display device. This utility will periodically check a specified website on the Internet to determine if a new update to any of the software is available. If an update is found, the system will alert the user with a visual indicator on the host that an update has been identified and that automatic download will start after a predefined elapsed time if not canceled by the user. If the user opens the alert, the user will have the option to initiate download of the update immediately or cancel the download and be reminded to do it later. If the user does not intervene, the download will start after the predetermined time. Once a download is successful, the update may be set to automatically install, or the user may elect to save the update file and run the update at a later time. If the user elects to postpone the installation, the system will provide a periodic reminder until the installation of the update is completed.

An update of the system management software should be an independent application that will stop the system, perform all necessary steps, and restart the system. If the installation is set to “automatic,” the system management software will run the update package at a time when display devices are not active, to reduce impact on the user. The update software should normally not require reboot of the host PC. If reboot is required, the system should notify the user that it needs to reboot and perform the process, if confirmed. If the user elects not to reboot at that time, the system will advise the user periodically that it needs to reboot to complete the update install. If the user elects to run the update while a display device is active, that display device will go into Detached Mode operation during the installation update process.

An update of the display software should also be an independent application that the system can install automatically, for execution the next time that a display device is started. Once a display update is received by the host PC, it will be automatically stored until the next scheduled off period for the display device. During the scheduled off period, the update will be transmitted to the display device and saved until the next start time. At the scheduled start time, the display device will automatically run the update and reboot to complete the process. The user will have the option to schedule any of the update steps manually, if desired.

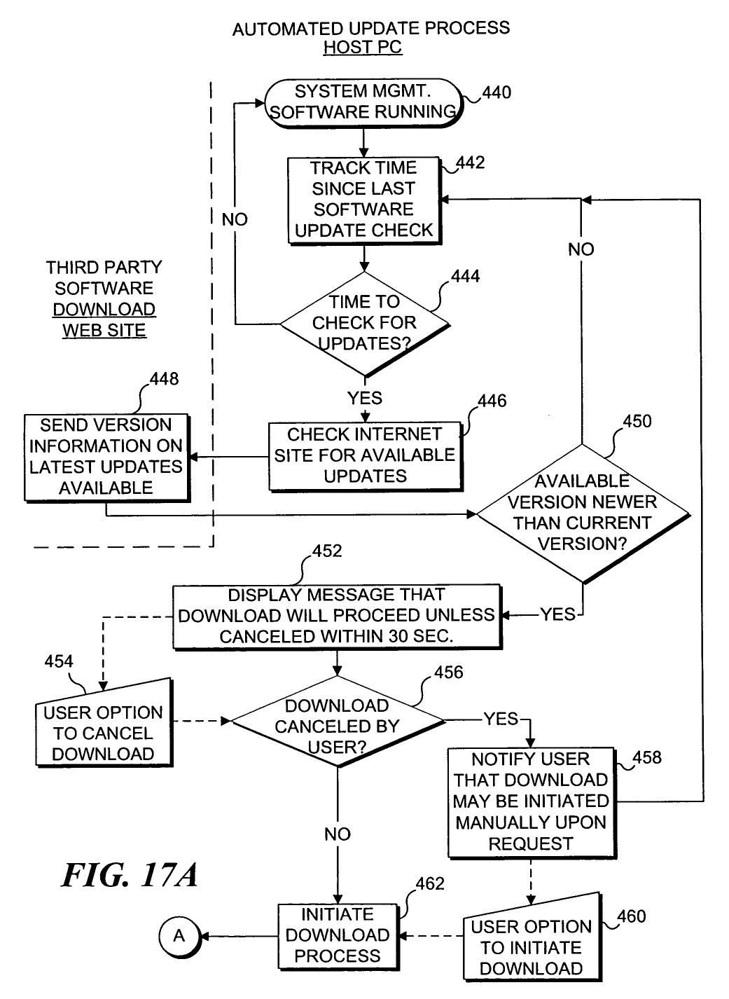

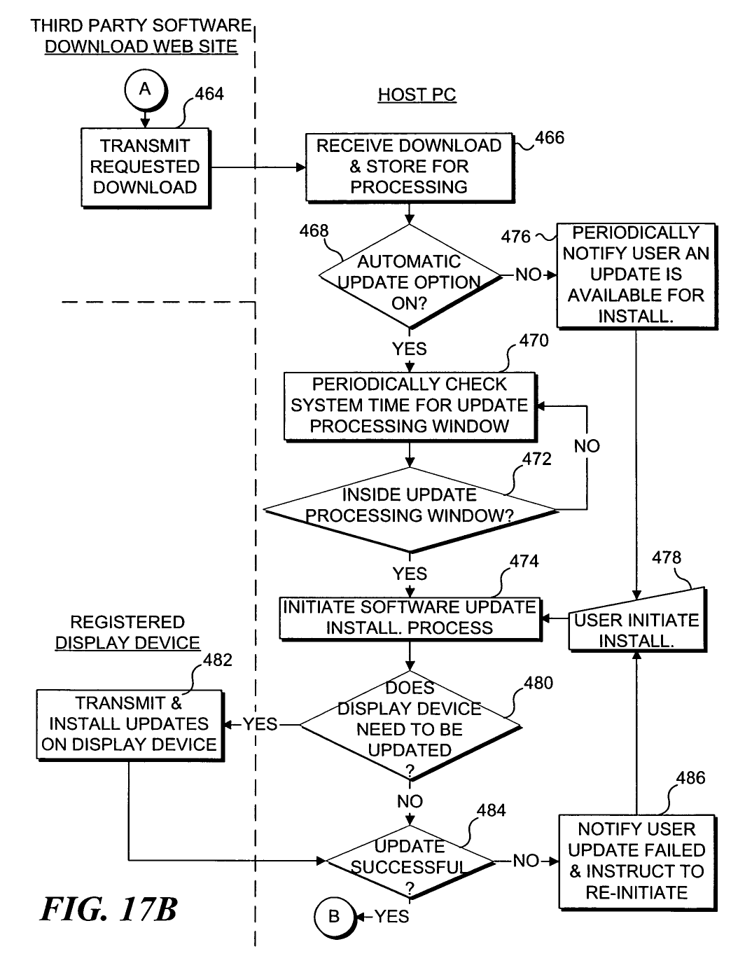

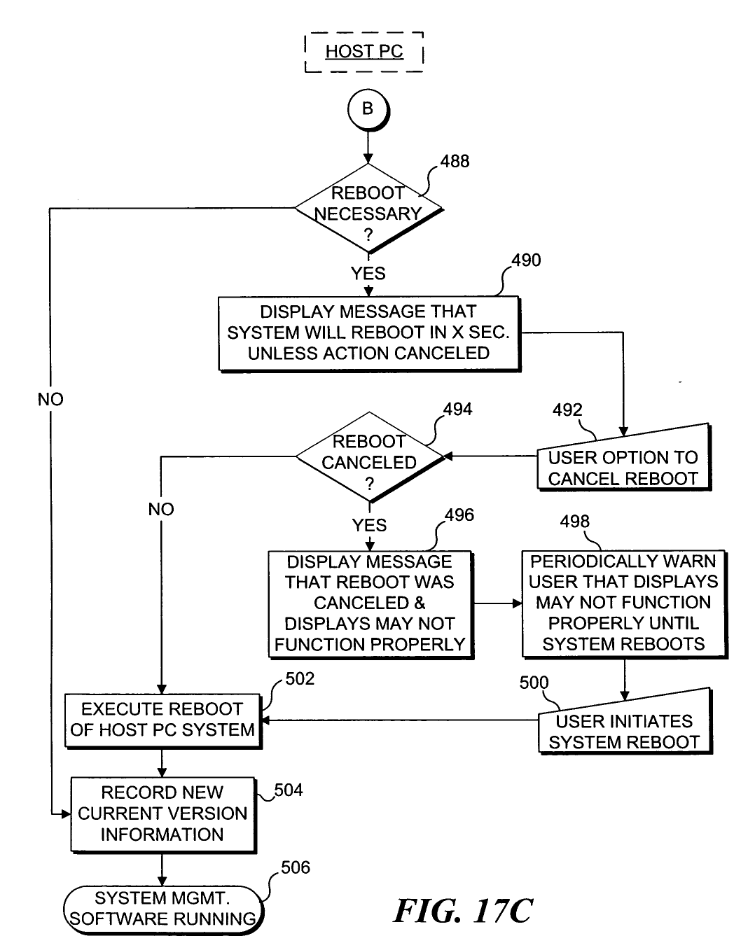

FIGS. 17A-17C illustrate a flowchart showing details of the steps for automatically updating either the system management software, or the display control software, and/or the display operating system software, as required. A step 440 indicates that the system management software is running. In a step 442, the software tracks the elapsed time since the last software update check was made. A decision step 444 determines if it is time to check for the availability of updates to the software, and if not, returns to step 440. If it is time to check for an update, a step 446 connects to an Internet site to check for available updates. Version information on the latest updates that are available are sent to the host PC in a step 448. A decision step 450 then determines if an available version is newer than the current version and if not, returns to step 442. However, if the available version is newer than the current version, a step 452 displays a message indicating that the download will proceed unless canceled within 30 seconds. Optionally, the user can cancel the download in a step 454. A decision step 456 determines if the download was canceled by the user, and if so, a step 458 notifies the user that the download may be initiated manually upon request. In a step 460, the user may optionally initiate the download. A negative response to decision step 456 leads to a step 462 that initiates the download process.

Continuing with FIG. 17B, a step 464 provides for transmitting the requested download to the host PC from the web site. In a step 466, the download is received by the host PC and stored for processing. A decision step 468 determines if the automatic update option has been turned on, and if so, a step 470 periodically checks the system “time for update processing window.” Next, a decision step 472 determines if the current time is within the update processing window and if so, a step 474 initiates the software update installation process. Referring back to decision step 468, if the automatic update option is not on, a step 476 periodically notifies the user that an update is available for installation. In a step 478, the user can manually initiate installation of the update, leading to step 474. After step 474, a decision step 480 determines whether the display device needs to be updated, and if so, a step 482 provides for transmitting and installing updates on the display device. Following either step 482 or a negative response to decision step 480, a decision step 484 determines if the update was successful. If not, a step 486 notifies the user that the update failed and instructs the user to reinitiate the update.

The logic continues in FIG. 17C. A decision step 488 determines if a reboot is necessary, and if so, a step 490 displays a message that the system will reboot within X seconds, unless the action is canceled by the user. A step 492 gives the user the option to cancel the reboot. A decision step 494 determines if the reboot has been canceled, and if so, a step 496 displays a message that the reboot was canceled and indicates that the display devices may not function properly. A step 498 periodically warns the user that the display devices may not function properly until the system has been rebooted. A step 500 indicates that the user may optionally initiate a reboot. Following step 500 or if the reboot was not canceled in decision step 494, a step 502 executes the reboot on the host PC system. Next, or if a reboot was not necessary in decision step 488, a step 504 records the new current version information. Finally, a step 506 indicates that the system management software is now again running.

Although the present invention has been described in connection with the preferred form of practicing it, those of ordinary skill in the art will understand that many modifications can be made thereto within the scope of the claims that follow. Accordingly, it is not intended that the scope of the invention in any way be limited by the above description, but instead be determined entirely by reference to the claims that follow.

The invention in which an exclusive right is claimed is defined by the following:

1. A display device for displaying content in a display cycle defined by parameters that are selectively input by a user, comprising:
(a) a touch display screen on which the content is displayed;
(b) a network interface device;
(c) a memory in which machine instructions are stored for implementing a plurality of instructions related to displaying the content; and
(d) a processor coupled to the network interface device, to the memory, and to the touch display screen and adapted to couple with a host system over a wireless network, said processor executing the machine instructions, including:
(i) coupling with a host computing device to receive the parameters for controlling the display cycle that are selectively input by a user and stored on a host computing device;
(ii) coupling with a storage on a host system to access the content that are selected by a user to display during the display cycle; and
(iii) enabling a user to selectively modify the display cycle by selectively activating the touch display screen.

2. The display device of claim 1, wherein the machine instructions stored in the memory further cause the processor to enable a user to selectively display content comprising a Secondary Content accessed over a public network.

3. The display device of claim 2, wherein the Secondary Content is provided on a subscription web site to which a user subscribes and is transmitted over the public network.

4. The display device of claim 1, wherein the machine instructions stored in the memory further cause the processor to carry out at least one of the following modifications to the display cycle, until the display cycle is selectively resumed:
(a) pause the display cycle to continuously display a content that is currently being displayed;
(b) switch to a next content in the display cycle and pause, continuously displaying the next content; and
(c) switch to a previous content in the display cycle and pause, continuously displaying the previous content.

5. The display device of claim 1, wherein the machine instructions enable a user to employ the touch display to send a content to a selected other person at a remote site, over a public network.

6. The display device of claim 5, wherein the content is sent in a peer-to-peer communication to another display device, over the public network.

7. The display device of claim 5, wherein the machine instructions cause the processor to download contact data for at least said selected other person from a host computing device, to enable a user to send the content to the other person who is selected.

8. The display device of claim 1, wherein the memory further comprises a cache into which at least a portion of the content displayed during the display cycle are downloaded from a storage of a host computing device and stored for subsequent display.

9. The display device of claim 1, wherein the machine instructions cause the processor to respond to activation of an option on the touch display to display a menu of options thereon from which a user may select a control function using the touch display.

10. A method for managing and displaying content on a remote display that is coupled over a network to a host computing device, comprising the steps of:
(a) enabling a user to input control parameters to the host computing device that are employed for controlling one or more aspects of the display of the content on the remote display, said control parameters being stored on the host computing device;
(b) transferring the control parameters from the host computing device to the remote display;
(c) applying the control parameters at the remote display to control the display of the content by the remote display; and
(d) responding to an input at the remote display by the user to provide an interactive control of the display of the content.

11. The method of claim 10, further comprising the step of enabling the user to select the content that are displayed on the remote display.

12. The method of claim 10, wherein the content displayed on the remote display are stored by the host computing device and downloaded by the remote display over the network.

13. The method of claim 10, wherein the content displayed on the remote display are stored on an external storage that is accessed over a public network.

14. The method of claim 10, wherein the remote display includes a touch screen, and wherein the user touches a control position on the touch screen to interactively control the display of the content on the remote display.

15. The method of claim 10, wherein the step of responding to the control of the remote display by the user includes the step of pausing a display of a content that is currently being displayed in response to the user activating a control on the remote display.

16. The method of claim 10, wherein the control parameters define a display cycle in which the content is sequentially displayed, each for predefined period of time.

17. The method of claim 10, further comprising the step of downloading and caching at least a portion of the content in a memory on the remote display, to enable display of the content to continue without continuously communicating with the host computing device.

18. The method of claim 10, further comprising the step of enabling the user to send a content to another person over a public network from the remote display.

19. The method of claim 18, further comprising the steps of
(a) displaying a list of people on the remote display in response to the user activating a control to send the content to another person;
(b) enabling the user to select a recipient of the content from among the list of people; and
(c) sending the content over the public network to the recipient selected by the user.

20. The method of claim 10, further comprising the steps of:
(a) automatically periodically scanning a storage for new content stored in the storage; and
(b) including the new content in the content that are displayed on the remote display.

21. The method of claim 20, wherein the step of including the new content is carried out in response to a user requesting that the new content be included in the content displayed on the remote display.

22. The method of claim 10, further including the step of enabling a user to attach a narrative to content that is to be displayed on the remote display.

23. The method of claim 10, further comprising the step of enabling a user to override the control parameters with a control input at the remote display.

24. The method of claim 10, wherein the control parameters include at least one of:
(a) hours of operation of the remote display for displaying the content;
(b) a content viewing duration;
(c) a current date;
(d) an aging limit for content that are displayed, so that after a content has been repetitively displayed for the aging limit, it is not displayed again; and
(e) a transition effect used between the display of successive content on the remote display.

25. The method of claim 10, further comprising the step of sharing content between host computing devices that are each coupled to a different remote display, so that the remote display coupled to one host computing device displays content stored on a different host computing device that is coupled to another remote display.

26. The method of claim 10, further comprising the step of enabling the user to select specific content to be displayed on different remote displays that are coupled to the host computing device over the network.

27. A memory medium on which are stored machine instructions for carrying out the steps of claim 10.

28. A system for managing the display of content at one or more distributed locations that are coupled together in a network, comprising:
(a) a host computing device that includes a storage for storing control parameters that have been input for controlling the display of the content at the one or more distributed locations; and
(b) a remote display that is coupled to the host computing device over the network, said remote display downloading the control parameters from the host computing device to establish a default set of conditions for displaying the content on the remote display and including a touch screen for input of user options that further affect the display of the content.

29. The system of claim 28, wherein the content is stored on a storage included on the host computing device.

30. The system of claim 28, wherein the content is stored at a remote storage that is coupled to the host computing device and to the remote display over a public network.

31. The system of claim 28, further comprising another remote device, wherein the host system executes a computer program that enables a user to select specific content to be displayed on the remote device and on the other remote device.

32. The system of claim 28, wherein the control parameters define a display interval during which each content is displayed on the remote display.

33. The system of claim 28, wherein the control parameters define at least one of:
(a) hours of operation of the remote display for displaying the content;
(b) a content viewing duration;
(c) a current date;
(d) an aging limit for content that are displayed, so that after a content has been repetitively displayed for the aging limit, it is not displayed again; and
(e) a transition effect used between the display of successive content on the remote display.

34. The system of claim 28, wherein the host computing device and the remote display are adapted to couple in a peer-to-peer communication with another host computing device and another remote display over a public network, to enable the remote display to display content that are stored at the other host computing device.

35. The system of claim 28, wherein a user is enabled to pause the display of a content on the remote display by selecting an control option on the touch screen of the remote display.

36. The system of claim 28, wherein the remote display responds to an input from a user by displaying a list of people, to enable a user to employ the touch screen to select a recipient of a content from the list of people, said remote display then sending the content to the recipient selected from the list over a public network that is coupled to the host computing device.

37. The system of claim 28, wherein the touch screen of the remote display responds to a user input to modify default parameters set by the control parameters that are downloaded from the host computing system to alter a display cycle used to display the content on the remote display.

38. The system of claim 28, wherein the remote display includes a cache for temporarily storing a portion of the content stored on the storage at the host computing device.
